(19) United States
(12) Patent Application Publication
(10) Pub. No.: US 2025/0051584 A1
(43) Pub. Date: Feb. 13, 2025

(54) COATING PREVENTING ICE ACCUMULATION ON SURFACES

(71) Applicant: BASF COATINGS GMBH, Muenster (DE)

(72) Inventors: Ravindra PATIL, Mangalore (IN); Rajkumar JANA, Mangalore (IN); Qingling ZHANG, Southfield, MI (US); Donald H. CAMPBELL, Hartland, MI (US)

(21) Appl. No.: 18/723,569

(22) PCT Filed: Jan. 27, 2023
(86) PCT No.: PCT/EP23/52045

§ 371 Date: Jun. 24, 2024

(30) Foreign Application Priority Data
Jan. 28, 2022 (EP) 22153920.8

(51) Int. Cl. C09D 5/16; C08G 18/40; C08G 18/61; C08G 18/63; C08G 18/79; C08K 9/00; C09D 7/40; C09D 7/62; C09D 175/04

(52) U.S. Cl. CPC C09D 5/1675; C08G 18/4072; C08G 18/61; C08G 18/638; C08G 18/791; C08K 9/00; C09D 7/62; C09D 7/67; C09D 175/04; C08K 2201/011

(57) ABSTRACT

Disclosed herein is a two-pack coating composition including A) a component A including Aa) one or more polysiloxanes with 4 or more isocyanate reactive groups; and Ab) one or more organic polymers, which differ from Aa) and which include a plurality of polysiloxane chains and isocyanate reactive functional groups; and B) a component B including Ba) a chemical species, which includes on average one or more free isocyanates groups and on average one or more hydrolysable silane groups and/or Bb) a chemical species including on average two or more free isocyanates groups and no hydrolysable silane groups. Also disclosed herein are a method of forming a cured coating layer on a substrate making use of the two-pack coating compositions and a method of using the two-pack coating composition for providing an icephobic coating to substrates.

The present invention relates to coating compositions and coatings produced thereof which prevent ice accumulation on surfaces, such as vehicle outer surfaces where, e.g., under severe weather conditions, an ice accumulation should be prevented. The invention further relates to a method of forming a cured coating layer making use of the coating compositions of the present invention and the use of the compositions for providing an icephobic coating to substrates.

### BACKGROUND

As snow or ice accumulates on vehicles, particularly automotive vehicles such as cars in winter, many of the sensors that are key to the operation of advanced safety systems can become inefficient. Vehicles with such sensors require additional and frequent cleaning which may not be feasible on driving mode particularly in snowing conditions.

Therefore, there is an ongoing need to provide coatings that will help to maintain sensor integrity/reliability under snowing conditions and ice formation conditions.

There have been numerous publications related to developing iceophobic surfaces. Such surfaces use different approaches including delaying droplet freezing time, preventing frost formation, and lowering ice adhesion strength.

Intrinsic ice adhesion is the atomistic attraction of frozen water molecules to a surface. Two most basic interactions, namely Coulomb and van der Waals forces, are responsible for intrinsic ice adhesion. Same as liquid water, ice can form hydrogen bonds with substrates with hydrogen bonding donors and/or acceptors, which enhances ice adhesion. An overview of polysiloxanes as icephobic materials can, e.g., be found in Chemical Engineering Journal, 2021, 405, 127088.

Amongst patent literature, WO 2016/176350 A1 describes a durable icephobic material comprising elastomeric urethane-based polymers or polydimethylsiloxane and optionally polysiloxane oils and others.

U.S. Pat. No. 5,035,934 discloses an adhesive sheet for preventing icing, which comprises a solid anti-icing layer, which is formed from a hydroxyl and fluor containing polyvinyl copolymer, a polyisocyanate compound and a mono-functional polysiloxane, the functional group of the mono-functional polysiloxane being reactive towards the polyvinyl copolymer and/or polyisocyanate compound.

WO 2015/179902 A1 discloses fluorinated polyhedral oligomeric silsequioxanes (FPOSS) possessing oleophobic and hydrophobic behavior from fluorinated side chains. Their use in coatings reducing ice formation is also disclosed. FPOSS can either be used as an additive in coating formulations, such as polysiloxane-polyisocyanate based coating formulations or it can be linked to a polyisocyanate; or be part of a polymeric backbone.

US 2013/0142957 A1 relates to a method of mitigating ice-build-up on a substrate, the method including the formation of a first and a second film-forming layer on a substrate, both layers being based on polyol-polyisocyanate or polysiloxane-silane curing systems.

U.S. Pat. No. 9,090,797 B2 also relates to a method of mitigating ice-build-up on a substrate. This method comprises applying and curing a curable film-forming composition on a substrate. The film-forming composition comprising: (a) a curing agent comprising isocyanate functional groups; (b) a film-forming polymer comprising functional groups reactive with the isocyanate groups in (a); (c) an acrylic polymer comprising (i) pendant functional groups reactive with the isocyanate groups in (a) and (ii) polysiloxane side chains; and (d) a polysiloxane different from the film-forming polymer (b) and the acrylic polymer (c).

US 2018/0163072 A1 relates to a stain resistant, soft touch coating composition and coatings formed therefrom. The coating compositions can be cured by isocyanate crosslinking and may contain acrylic polymers comprising pendant functional groups reactive with the isocyanate groups of the crosslinker and polysiloxane side chains, as well as polyester polyols, fluor and hydroxyl containing polyvinyl polymers and silicone additives.

U.S. Pat. No. 7,910,683 B2 relates to tough and strongly-adherent anti-icing coatings based on polysiloxane (amide-ureide) polymers which inhibit the ability of ice to adhere to a surface of a physical object, said polysiloxane (amide-ureide) polymer comprises a back bone comprising the reaction product of at least one diamine-terminated polysiloxane, at least one an aromatic diamine, at least one diisocyanate and at least one halide substituted dicarboxylic acid.

It was the aim of the present invention to provide coating compositions for coating a variety of different substrates which are further improved with respect to their ability to prevent an ice-build-up on the thus coated substrates, particularly to reduce the ice block falling temperature (IBF temperature). While quite some of the existing icephobic coatings contain fluorine containing ingredients, the coating compositions of the present invention should not need to incorporate such environmentally problematic fluorine-based resins, but should rely on silicon-based binders.

### SUMMARY

The aim of the present invention was achieved by providing a two-pack coating composition comprising
A) a component A comprising
   Aa) one or more polysiloxanes with 4 or more isocyanate reactive groups; and
   Ab) one or more organic polymers, which differ from Aa) and which comprise a plurality of polysiloxane chains and isocyanate reactive functional groups; and
B) a component B comprising
   Ba) a chemical species, which comprises on average one or more free isocyanates groups and on average one or more hydrolysable silane groups; and/or
   Bb) a chemical species comprising on average two or more free isocyanates groups and no hydrolysable silane groups.

The term “two-pack coating composition” (also denoted as “two-component coating compositions”) as used herein and being in accordance with the understanding of one of skill in the art of coatings, stands for coating compositions, where the chemical reaction leading to the curing of the coating composition is initiated by mixing of at least two components. The two components are as such no coating compositions, because they are not apt to film-forming or they do not form durable films (Keyword: “Zweikomponenten-Lacke” (two-component coating compositions) in Römpp Lexikon “Lacke und Druckfarben” (Römpp Encyclopedia “Coatings and Printing Inks”), 1998).

The term “isocyanate reactive group” refers to a group that is apt to react with a free isocyanate group (NCO group). For all embodiments of component A, as described herein below, the most preferred isocyanate reactive group is a hydroxyl group. The term “isocyanate group” refers to free isocyanate groups.

The term “plurality” means two or more.

The term “hydrolysable silane group” refers to silane groups which comprise residues bound to the Si atom of the silane group, those residues being apt to react with water to form Si—OH groups, which may further react, e.g., by condensation reaction with each other, further hydrolysable silane groups and/or carbon-bound hydroxyl groups.

In the following, this coating composition and its preferred embodiments are denoted as “coating compositions according to the present invention”.

Further object of the present invention is a method of forming a cured coating layer at least partially on at least one surface of a substrate, wherein said method comprises the following steps:
(a) applying the coating composition according to the present invention at least partially onto at least one surface of an optionally pre-coated substrate to form a coating layer on the surface of the substrate; and subsequently
(b) curing the coating layer obtained in step (a) to form a cured coating layer on the surface of the substrate.

In the following, this method and its preferred embodiments are also called “method according to the present invention”.

Yet another object of the invention is the use of the coating compositions of the present invention for providing an icephobic coating to substrates, such as aircrafts and parts thereof like the airframe, fuselage and wings, vehicles bodies, such as automotive bodies and parts thereof; and wind turbines and parts thereof, such as rotor blades.

In the following, this use and its preferred embodiments are also denoted as “use according to the present invention”.

### DETAILED DESCRIPTION

### Two-Pack Coating Composition

The two-pack coating compositions according to the present invention comprise at least components A and B as described above to obtain icephobic coatings on different substrates. However, to optimize their viscosity for particular application techniques, such as spray application, it is preferred to dilute the coating compositions with one or more solvents contained in component C, which will be described herein below. The solvents of components C can be used to dilute any of the other components, particularly components A and B or both, or to dilute or dissolve the ingredients used in any of the components. Furthermore, the coating compositions can contain diverse further ingredients as summarized under the headline “Component D”, such as catalysts to accelerate the reactions, particularly the reactions between components A and B. Further included in component D are additives, which might even lead to a further improvement in icephobicity such as silica nanoparticles, but also additives helping to enhance the outdoor and weathering resistance, such as UV absorbers and light stabilizers.

In the following, first, the essential ingredients of components A and B will be described in more detail and in form of preferred features and embodiments, followed by the optional components C and D. Finally, the preferred amounts and ratios of components and/or their ingredients will be described in the following.

### Component A

Component A comprises chemical species Aa) and Ab) as further described herein below.

The Aa) Polysiloxane with 4 or More Isocyanate Reactive Groups

Generally, the Aa) polysiloxanes are obtainable by chemical addition reaction of preferably at least two ethylenically unsaturated monomers to Si—H groups present at a polyorganosiloxane, most preferably at an α,ω-dihydrogen polydiorganosiloxane, the ethylenically unsaturated monomers each comprising one or more, preferably two isocyanate reactive groups.

Preferably the Aa) one or more polysiloxanes with 4 or more functional isocyanate reactive groups are linear polyorganosiloxanes which carry the isocyanate reactive groups at the alpha- and omega-terminal ends of the chain, preferably two isocyanate reactive groups at each terminal end.

Particularly preferred, the Aa) one or more polysiloxanes with 4 or more functional isocyanate reactive groups are the adducts of diols and/or triol having an allyl functional group such as in trimethylolpropane mono allyl ether (to introduce 4 isocyanate reactive groups Y) and/or pentaerythritol mono allyl ether (to introduce 6 isocyanate reactive groups Y) with dihydrogen polysiloxanes, such as α,ω-dihydrogen polydialkylsiloxane, like α,ω-dihydrogen polydimethylsiloxane.

Amongst the afore-mentioned Aa) one or more polysiloxanes with 4 or more functional isocyanate reactive groups, those having the following formula (I) are preferred:

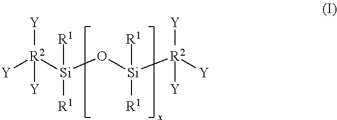

wherein the
R¹ groups are independently selected from alkyl groups having 1 to 4 carbon atoms and phenyl groups; the
R² groups are independently selected from branched or linear aliphatic hydrocarbon groups, which may be interrupted by one or more ether oxygen atoms; the
Y groups are independently H or isocyanate reactive groups, with the proviso that at least 4 Y groups are isocyanate reactive groups; and
x is a number in the range from 4 to 40.

More preferred the R¹ groups are independently from each other alkyl groups having 1 to 4 carbon atoms, even more preferred 1 to 3 carbon atoms and most preferred groups R¹ are ethyl or methyl groups amongst which the methyl groups are even further preferred. Most preferred all R¹ groups are methyl groups.

More preferred the R² groups are linear or branched, preferably branched aliphatic hydrocarbon groups, preferably containing 3 to 14 carbon atoms, which may be interrupted by one or more ether oxygen atoms, preferably one ether oxygen atom. As per definition a hydrocarbon group contains only carbon and hydrogen atoms. However, in the present invention it is allowed that such groups R² are interrupted by ether oxygen atoms. The term “interrupted” means, as commonly used and used herein, that the ether oxygen atom is between two carbon atoms, such that in case of such interruption by one ether oxygen atom, residue R²=(hydrocarbon group part 1)-O-(hydrocarbon group part 2).

Preferably all hydrocarbon groups R¹, R², R³ and R⁴ are saturated hydrocarbon groups in all embodiments of formula (I).

The groups Y are hydrogen or isocyanate reactive groups Y. Preferred isocyanate reactive groups are selected from primary and secondary hydroxyl groups, primary and secondary thiol groups, and primary and secondary amino groups, preferably the isocyanate reactive groups Y are hydroxyl groups, even more preferred primary hydroxyl groups. In case Y is an amino group and too much gelling occurs, it is advisable to switch to the hydroxy functional alternatives.

While the number of isocyanate reactive groups Y is at least 4, it is preferred that 4 to 6 groups Y are isocyanate reactive groups, preferably hydroxyl groups and most preferred primary hydroxyl groups. In case only two or less than two isocyanate reactive groups Y are present in the species of formula (I), no icephobicity is observed.

It is particularly preferred that at both terminal ends of the species of formula (I) at least 2 groups Y are isocyanate reactive groups, even more preferred that at both terminal ends of the species of formula (I) at least 2 groups Y are hydroxyl groups.

The average number of units [—O—Si(R¹)₂] is x. Preferably, x ranges from 5 to 35, more preferred from 6 to 25, even more preferred from 8 to 20 and most preferred from 10 to 18. The average number of x can be calculated by determination of the number-average molecular weight of the compounds of formula (I) by gel permeation chromatography as described in more detail in the experimental section of the present invention, knowing which end groups R²(Y)₃ are attached and which type of polysiloxane backbone was selected, e.g., polydimethylsiloxane.

It is further preferred that, if the number of isocyanate reactive groups Y is as low as 4, the value for x should also be in the lower range such as 4 to 18, while, if the number of isocyanate reactive groups Y is e.g., 5 or 6, the value for x is preferably in the middle or higher range such as 8 to 35.

If the number-average molecular weight is too high (large x value) and the functionality of isocyanate reactive groups is too low, the solubility of the polysiloxane in the coating composition might be low and the crosslinking density of the formed network decreases, too.

In an even more preferred embodiment, (Y)₃R²═(Y—CH₂)₂R³—O—R⁴ or (Y—CH₂)₃R³—O—R⁴, wherein R³ is a hydrocarbon group containing 1 to 8, more preferred 1 to 6 and most preferred 2 to 4 carbon atoms and R⁴ is a hydrocarbon group containing 1 to 6, more preferred 2 to 5 and most preferred 3 or 4 carbon atoms and being bound to the adjacent Si atom in formula (I) and groups Y are isocyanate reactive groups, preferably hydroxyl groups.

In a particularly preferred embodiment both residues (Y)₃R² in the species of formula (I) stand for (HO—CH₂)₂(CH₃CH₂)C(CH₂)—O—(CH₂)₃, R¹ is methyl and x is approx. 14. In such case the number-average molecular weight is approx. 1400 g/mol, and the OH number is approx. 159 mg KOH/g. Such products are e.g., available by addition reaction of 2 moles trimethylolpropane allyl ether to one mole of an α,ω-dihydrogen polydimethylsiloxane.

For any of the Aa) polysiloxane with 4 or more functional isocyanate reactive groups, it is preferred, that the OH value of the Aa) polysiloxane is in the range from 100 to 400 mg KOH/g, more preferred 120 to 300 mg KOH/g, even more preferred 140 to 260 mg KOH/g and most preferred 150 to 250 mg KOH/g such as 150 to 200 mg KOH/g.

Products of formula (I) are, e.g., commercially available from Siltech Corp. (Toronto, Canada) under the tradename Silmer®, particularly preferred as Silmer® OHT Di-10.

### The Ab) Organic Polymer Comprising Polysiloxane Chains and Isocyanate Reactive Functional Groups

The Ab) one or more organic polymers comprising a plurality of polysiloxane chains (also named herein polydiorganosiloxane chains) and a plurality of isocyanate reactive functional groups can be further characterized by having an organic polymeric backbone, preferably selected from polyesters, polyurethanes and poly(meth)acrylates, most preferably selected from poly(meth)acrylates. The organic polymeric backbone comprising a plurality of pendant and/or terminal hydroxyl groups and comprising a plurality of pendant and/or terminal polysiloxane chains, preferably comprising a plurality of pendant polysiloxane chains.

The term “(meth)acrylate” or “(meth)acrylic” refers to both methacrylate and acrylate, and methacrylic and acrylic, respectively. Thus, a poly(meth)acrylate is a polymer or resin containing polymerized acrylate monomers and/or polymerized methacrylate monomers; and, as known to one of skill in the art poly(meth)acrylates may comprise further polymerized monomers which differ from (meth)acrylates such as, but not limited to (meth)acrylic acid, vinyl monomers such as styrene, or (meth)acryl amides.

The polydiorganosiloxane chains, preferably the polydimethylsiloxane chains in the Ab) one or more organic polymers, preferably have a weight-average molecular weight in the range of 1000 and 30,000 g/mol as determined by gel permeation chromatography using a polystyrene standard. The chains are preferably terminated with hydrocarbon groups having 1 to 8 carbon atoms, preferably branched or linear alkyl groups with 1 to 8 carbon atoms; the hydrocarbon groups or alkyl groups may be substituted or unsubstituted.

The polydiorganosiloxane chains can be introduced into the poly(meth)acrylate backbone by copolymerization of monoethylenically unsaturated polydiorganosiloxane macromonomers with the other ethylenically unsaturated monomers, particularly the other (meth)acrylic monomers. Such macromonomers can, e.g., be alpha-alkyldimethylsiloxy-omega-(3-methacryloyloxypropyl) polydimethylsiloxanes as, e.g., described in U.S. Pat. No. 7,122,599 B2 (col. 5, II. 2 to 10).

Another possibility to introduce the polydiorganosiloxane chains to the polymeric backbone is, e.g., by using a polydiorganosiloxane macromolecule being monoterminally functionalized with a reactive group that is apt to react with a functional group on the polymeric backbone. Such macromonomers can, e.g., be alpha-alkyldimethylsiloxy-omega-(3-(2-hydroxyethoxy)-propyl) polydimethylsiloxanes as, e.g., described in U.S. Pat. No. 7,122,599 B2 (col. 5, II. 35 to 45).

Finally, yet another possibility to introduce the polydiorganosiloxane chains to the polymeric backbone is described in U.S. Pat. No. 7,122,599 B2 (col. 5, II. 46 to 54).

The weight-average molecular weights of the polysiloxane chains, i.e., the polydiorganosiloxane chains, can be determined on the afore-mentioned macromolecules before their introduction into the polymeric backbone by gel permeation chromatography using a polystyrene standard.

In the present invention it is preferred, that the one or more organic polymers comprising a plurality of polysiloxane chains and a plurality of isocyanate reactive functional groups, have a poly(meth)acrylate backbone, a plurality of pendant polysiloxane chains, preferably polydimethylsiloxane chains and a plurality of pendant hydroxyl groups as isocyanate reactive groups.

In case the Ab) one or more organic polymers comprise hydroxyl groups as isocyanate functional groups, the Ab) one or more organic polymers preferably have hydroxyl numbers in the range of 5 to 100, often 10 to 80, and more often 20 to 60 mg KOH/g.

In case the Ab) one or more organic polymers possess a poly(meth)acrylate backbone, the hydroxyl groups can be introduced by (co)polymerizing hydroxy functional (meth)acrylates, such as hydroxyalkyl (meth)acrylates in the manufacture of the poly(meth)acrylate backbone.

Preferably, the weight-average molecular weight of the Ab) one or more organic polymers comprising a plurality of polysiloxane chains and a plurality of isocyanate reactive functional groups is in the range of 3,000 to 100,000, often 4,000 to 80,000 and more often 5,000 to 60,000 g/mol.

The above hydroxyl numbers are determined by titration and the weight-average molecular weights are determined by gel permeation chromatography using a polystyrene standard as described in more detail in the experimental section of the present invention. The above hydroxyl numbers and weight-average molecular weights independently apply to any of the Ab) one or more organic polymers comprising a plurality of polysiloxane chains and a plurality of isocyanate reactive functional groups, irrespective of the nature of their backbone. However, a poly(meth)acrylic backbone is preferred in all cases.

With respect to the total weight of the Ab) one or more organic polymers comprising a plurality of polysiloxane chains and a plurality of isocyanate reactive functional groups, the content of polysiloxane chains is preferably in the range of 5 to 25 wt.-%. This content can be calculated from the weight of the polydiorganosiloxane macromolecules used in the manufacture of the Ab) one or more organic polymers, and the monomers used in the manufacture of the polymeric backbone.

Suitable organic polymers comprising a plurality of polysiloxane chains and a plurality of isocyanate reactive functional groups are disclosed in U.S. Pat. No. 7,122,599, column 2, line 35 to column 7, line 40. A particularly suitable (meth)acrylic polymer comprising a plurality of polydimethylsiloxane chains and a plurality of hydroxyl groups is BYK-SILCLEAN 3700, available from BYK-Chemie GmbH.

### Component B

Component B comprises chemical species Ba) and/or Bb) as further described herein below.

### Chemical Species Ba), Comprising on Average One or More Free Isocyanates Groups and on Average One or More Hydrolysable Silane Groups

A chemical species comprising on average at least one free isocyanate groups and at least one hydrolysable silane group is preferably obtainable by reacting a diisocyanate or polyisocyanate with one or more hydrolysable silanes which comprise at least one isocyanate reactive group. The term “chemical species” refers to an organic compound, oligomer or polymer. The term “diisocyanate” as used herein refers to a compound having two free isocyanate groups, while the term “polyisocyanate” refers herein to a compound having more than two free isocyanates on average.

The diisocyanates and/or polyisocyanates which serve as parent structures for manufacture of the chemical species used in accordance with the invention are preferably substituted or unsubstituted aromatic, aliphatic, cycloaliphatic and/or heterocyclic diisocyanates and/or polyisocyanates.

Examples of preferred diisocyanates are as follows: 2,4-toluene diisocyanate, 2,6-toluene diisocyanate, diphenylmethane 4,4′-diisocyanate, diphenylmethane 2,4′-diisocyanate, p-phenylene diisocyanate, biphenyl diisocyanates, 3,3′-dimethyl-4,4′-diphenylene diisocyanate, tetramethylene 1,4-diisocyanate, hexamethylene 1,6-diisocyanate, 2,2,4-trimethylhexane 1,6-diisocyanate, isophorone diisocyanate, ethylene diisocyanate, 1,12-dodecane diisocyanate, cyclobutane 1,3-diisocyanate, cyclohexane 1,3-diisocyanate, cyclohexane 1,4-diisocyanate, methylcyclohexyl diisocyanates, hexahydrotoluene 2,4-diisocyanate, hexahydrotoluene 2,6-diisocyanate, hexahydrophenylene 1,3-diisocyanate, hexahydrophenylene 1,4-diisocyanate, perhydrodiphenylmethane 2,4′-diisocyanate, 4,4′-methylenedicyclohexyl diisocyanate (e.g., Desmodur® W from Bayer AG), tetramethylxylyl diisocyanates (e.g., TMXDI® from American Cyanamid), and mixtures of the aforementioned diisocyanates.

Most preferred are polyisocyanates obtained by oligomerization of the afore-mentioned diisocyanates. Particularly preferred under those are the biuret, allophanate, uretdion, containing polyisocyanates obtained by reacting the aforementioned diisocyanates with one or more or monohydroxy functional compounds and/or water. Further preferred are the iminooxadiazindione oligomers, preferably trimers and isocyanurate oligomers, preferably trimers of the aforementioned diisocyanates. Particularly preferred are the isocyanurate trimers of the aforementioned diisocyanates.

Particularly preferred diisocyanates and polyisocyanates are aliphatic diisocyanates and polyisocyanates. Even more preferred are hexamethylene 1,6-diisocyanate, isophorone diisocyanate, and 4,4′-methylenedicyclo-hexyl diisocyanate, and particularly their iminooxadiazindione and isocyanurate oligomers, particularly trimers; but also the biurets, uretdiones, and allophanates.

To obtain the chemical species comprising on average at least one free isocyanate groups and at least one hydrolysable silane group, one or more isocyanate groups of diisocyanates or polyisocyanates are reacted with a hydrolysable silane comprising an isocyanate reactive group.

Preferably the hydrolysable silanes to be used in the manufacture of the Ba) chemical species comprising on average at least one free isocyanate group and at least one hydrolysable silane group are selected from the groups of isocyanate reactive monosilanes, containing one hydrolysable silane group, and isocyanate reactive bissilanes, containing two hydrolysable silane groups.

Hydrolysable monosilanes and bissilanes, which are suitable to be reacted with at least one isocyanate group of a diisocyanate or polyisocyanate can be depicted by the following formula (II)

H—Z—X—Si(Rᵢ)_{y}(ORⁱⁱ)_{3-y} (II)
wherein
Z═NH, or preferably NRⁱⁱⁱ or O;
y=0, 1 or 2;
Rⁱ=are independently of each other alkyl groups having 1 to 4, preferably 1 or 2 carbon atoms;
Rⁱⁱ=are independently of each other H or preferably alkyl groups with 1 to 4, preferably 1 or 2 carbon atoms;
Rⁱⁱⁱ=a hydrocarbon group having 1 to 10 carbon atoms, or a hydrocarbon group being interrupted by one or more of the following groups —O—, —S— or NR^{iv}, wherein R^{iv} being an alkyl group with 1 to 6 carbon atoms, a cycloalkyl group with 3 to 10 carbon atoms, an aryl group with 6 to 10 carbon atoms or aralkyl group with 7 to 10 carbon atoms; or Rⁱⁱⁱ being a group X—Si(Rⁱ)_{z}(ORⁱⁱ)_{3-z}, wherein z=0, 1 or 2; and
X=a linear or branched alkylene group having 1 to 20, preferable 1 to 6 and even more preferred 1, 2 or 3 carbon atoms or a cycloalkylene group having 3 to 14, preferably 3 to 10 and even more preferred 3 to 6 carbon atoms.

If Z=NRⁱⁱⁱ with Rⁱⁱⁱ being a group X—Si(Rⁱ)(ORⁱⁱ)_{3-z}, wherein z=0, 1 or 2 and y, X, Rⁱ and Rⁱⁱ are defined as above, the hydrolysable silane is a bissilane, which thus introduces two hydrolysable silane groups into the chemical species Ba) chemical species comprising on average one or more free isocyanates groups and on average one or more hydrolysable silane groups.

Particularly preferred hydrolysable monosilanes and bissilanes of formula (II) are those, wherein
Z=NRⁱⁱⁱ;
y=0 or 1;
Rⁱ=are independently of each other alkyl groups having 1 or 2 carbon atoms;
Rⁱⁱ=are independently of each other alkyl groups having 1 or 2 carbon atoms;
Rⁱⁱⁱ=an alkyl group having 1 to 10 carbon atoms, preferably 1 to 6 or 1 to 4 carbon atoms; or Rⁱⁱⁱ being a group X—Si(Rᵢ)_{z}(ORⁱⁱ)_{3-z}, wherein z=0 or 1; and
X=a linear or branched alkylene group having 1, 2 or 3 carbon atoms, preferably 1 or 3 carbon atoms.

Preferred monosilanes are, e.g., omega-aminoalkyl- or omega-hydroxyalkyltrialkoxysilanes, such as, preferably, 2-aminoethyltrimethoxysilane, 2-aminoethyltriethoxysilane, 3-aminopropyltrimethoxysilane, 3-aminopropyl-triethoxysilane, 4-aminobutyltrimethoxysilane, 4-aminobutyltriethoxysilane, 2-hydroxyethyltrimethoxysilane, 2-hydroxyethyltriethoxysilane, 3-hydroxypropyl-trimethoxysilane, 3-hydroxypropyltriethoxysilane, 4-hydroxybutyltrimethoxysilane, and 4-hydroxybutyltriethoxysilane. Particularly preferred are N-(2-(trimethoxysilyl)-ethyl)alkylamines, N-(3-(trimethoxysilyl)propyl)alkylamines, N-(4-(trimethoxysilyl)-butyl)alkylamines, N-(2-(triethoxy-silyl)ethyl)alkylamines, N-(3-(triethoxysilyl)propyl)-alkylamines and/or N-(4-(triethoxysilyl)butyl)alkylamines. N-(3-(trimethoxy-silyl)-propyl)butylamine is especially preferred. Aminosilanes of this kind are available for example under the brand name DYNASYLAN® from Evonik Industries or Silquest® from OSI.

Preferred bissilanes are bis(2-ethyltrimethoxysilyl)amine, bis(3-propyl-trimethoxysilyl)amine, bis(4-butyltrimethoxysilyl)amine, bis(2-ethyltriethoxysilyl)amine, bis(3-propyltriethoxysilyl)amine and/or bis(4-butyltriethoxysilyl)amine. Bis(3-propyltrimethoxysilyl)amine is especially preferred. Aminosilanes of this kind are available for example under the brand name DYNASYLAN® from Evonik Industries or Silquest® from OSI.

Particularly preferred chemical species Ba) as employed in the coating composition according to the present invention, are based on trimers, such as isocyanurate trimers of diisocyanates as exemplified by the following formula (III):

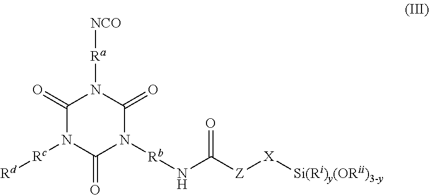

wherein
Z, X, Rⁱ, Rⁱⁱ and y are defined as for formula (II);
R^{a}, R^{b} and R^{c} are independently of each other aliphatic or aromatic, preferably aliphatic hydrocarbon groups, even more preferred linear or branched alkylene groups with 2 to 18, preferably 4 to 14 and even more preferred 6 to 10 carbon atoms or cycloalkylene groups with 6 to 10 carbon atoms; and
R^{d} being an isocyanate group or an NH—(C=O)—Z—X—Si(Rⁱ)_{y}(ORⁱⁱ)_{3-y} group.

In species of formula (III) it is even more preferred that
Z is NRⁱⁱⁱ;
y is 0 or 1;
Rⁱ are independently of each other alkyl groups having 1 or 2 carbon atoms;
Rⁱⁱ are independently of each other alkyl groups having 1 or 2 carbon atoms;
Rⁱⁱⁱ is an alkyl group having 1 to 10 carbon atoms, preferably 1 to 6 or 1 to 4 carbon atoms; or Rⁱⁱⁱ being a group X—Si(Rⁱ)_{z}(ORⁱⁱ)_{3-z}, wherein z=0 or 1;
X is a linear or branched alkylene group having 1, 2 or 3 carbon atoms, preferably 1 or 3 carbon atoms;
R^{a}, R^{b} and R^{c} are independently of each other aliphatic hydrocarbon groups, preferably linear alkylene groups with 6 to 10 carbon atoms, as most preferred hexamethylene groups; or the hydrocarbon residue formed by abstraction of the two NCO groups of an isophorone diisocyanate; and
R^{d} being NCO or an NH—(C=O)—Z—X—Si(Rⁱ)_{y}(ORⁱⁱ)_{3-y} group.

Amongst the afore-mentioned preferred species of formula (III) it is even further preferred that Z is NRⁱⁱⁱ, y is 0, Rⁱⁱ is methyl, Rⁱⁱⁱ is an alkyl group having 1 to 6 carbon atoms or a group X—Si(ORⁱⁱ)₃, X is methylene or propylene, preferably propylene, R^{a}, R^{b} and R^{c} are the same and are linear alkylene groups with 6 to 10 carbon atoms, preferably 6 carbon atoms; and R^{d} being NCO or an NH—(C=O)—Z—X—Si(ORⁱⁱ)₃ group.

Most preferably a part of the Rⁱⁱⁱ groups are alkyl group having 1 to 6 carbon atoms and the residual Rⁱⁱⁱ groups are X—Si(ORⁱⁱ)₃ groups, i.e., monosilane and bissilane residues are present in the species of formula (III).

Thus, it is to be understood that mixtures of species of formula (III) can also be employed. Such mixtures may comprise species with one isocyanate group and one or two hydrolysable silane groups introduced by one or two monosilanes, or two hydrolysable silane groups introduced by one bissilane up to four hydrolysable silane groups introduced by two bissilanes, where the hydrolysable silane groups may me same of different and can be selected from monosilanes and bissilanes or both in one species of formula (III). Mixtures of species of formula (III) may, however, also comprise species having two isocyanate groups and just one NCO groups which is reacted with a monosilane or bissilane of the above formula (II).

Thus, the terms “on average one or more free isocyanates groups” and “on average one or more hydrolysable silane groups” mean that the diisocyanate or polyisocyanate starting product and the monosilane and/or bissilane starting products are selected in amounts allowing that—on average—at least one free isocyanate group remains in the diisocyanate or polyisocyanate starting product and that—on average—at least one hydrolysable silane group is introduced into the Ba) chemical species by reacting the diisocyanate or polyisocyanate starting product with a monosilane or bissilane.

For any of the Ba) chemical species comprising on average one or more free isocyanates groups and on average one or more hydrolysable silane groups, it is preferred, that the NCO content of the Ba) chemical species is in the range from 6 wt.-% to 14 wt.-%, more preferred in the range from 8 wt.-% to 12 wt.-%, such as from 9 to 11 wt.-%, based on the total weight of the Ba) chemical species as defined above.

### Chemical Species Bb), Comprising on Average Two or More Free Isocyanates Groups and No Hydrolysable Silane Groups

Chemical species Bb) comprising on average at least two free isocyanate groups and no hydrolysable silane group will be described below. The term “chemical species” refers to an organic compound, oligomer or polymer as for chemical species Ba). The term “diisocyanate” again refers to a compound having two free isocyanate groups, while the term “polyisocyanate” refers herein to a compound having more than two free isocyanates on average.

The chemical species Bb) are preferably diisocyanates and/or polyisocyanates, which are preferably selected from the group consisting of substituted or unsubstituted aromatic, aliphatic, cycloaliphatic and/or heterocyclic diisocyanates and/or polyisocyanates.

Examples of preferred diisocyanates are as follows: 2,4-toluene diisocyanate, 2,6-toluene diisocyanate, diphenylmethane 4,4′-diisocyanate, diphenylmethane 2,4′-diisocyanate, p-phenylene diisocyanate, biphenyl diisocyanates, 3,3′-dimethyl-4,4′-diphenylene diisocyanate, tetramethylene 1,4-diisocyanate, hexamethylene 1,6-diisocyanate, 2,2,4-trimethylhexane 1,6-diisocyanate, isophorone diisocyanate, ethylene diisocyanate, 1,12-dodecane diisocyanate, cyclobutane 1,3-diisocyanate, cyclohexane 1,3-diisocyanate, cyclohexane 1,4-diisocyanate, methylcyclohexyl diisocyanates, hexahydrotoluene 2,4-diisocyanate, hexahydrotoluene 2,6-diisocyanate, hexahydrophenylene 1,3-diisocyanate, hexahydrophenylene 1,4-diisocyanate, perhydrodiphenylmethane 2,4′-diisocyanate, 4,4′-methylenedicyclohexyl diisocyanate (e.g., Desmodur® W from Bayer AG), tetramethylxylyl diisocyanates (e.g., TMXDI® from American Cyanamid), and mixtures of the aforementioned diisocyanates.

Most preferred are polyisocyanates obtained by oligomerization of the afore-mentioned diisocyanates. Particularly preferred under those are the biuret, allophanate, uretdion, containing polyisocyanates obtained by reacting the aforementioned diisocyanates with one or more or monohydroxy functional compounds and/or water. Further preferred are the iminooxadiazindione oligomers, preferably trimers and isocyanurate oligomers, preferably trimers of the aforementioned diisocyanates. Particularly preferred are the isocyanurate trimers of the aforementioned diisocyanates.

Particularly preferred diisocyanates and polyisocyanates are aliphatic diisocyanates and polyisocyanates. Even more preferred are hexamethylene 1,6-diisocyanate, isophorone diisocyanate, and 4,4′-methylenedicyclo-hexyl diisocyanate, and particularly their iminooxadiazindione and isocyanurate oligomers, particularly trimers; but also, the biurets, uretdiones, and allophanates.

Particularly preferred chemical species Bb) as employed in the coating composition according to the present invention, are based on trimers, such as isocyanurate trimers of diisocyanates as exemplified by the following formula (IV):

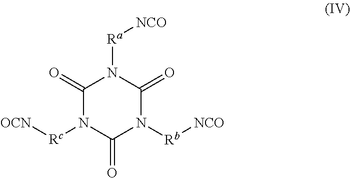

wherein
R^{a}, R^{b} and R^{c} are independently of each other aliphatic or aromatic, preferably aliphatic hydrocarbon groups, even more preferred linear or branched alkylene groups with 2 to 18, preferably 4 to 14 and even more preferred 6 to 10 carbon atoms or cycloalkylene groups with 6 to 10 carbon atoms.

Most preferred R^{a}, R^{b} and R^{c} independently stand for the hydrocarbon residues of hexamethylene 1,6-diisocyanate, isophorone diisocyanate, and 4,4′-methylenedicyclo-hexyl diisocyanate from which the respective two isocyanate groups were “subtracted”.

In the present invention, as component B, chemical species Ba) or Bb); or Ba) and Bb) can be used as described above.

### Chemical Species Bc), Comprising No Free Isocyanates Groups and on Average One or More Hydrolysable Silane Groups

The presence of Bc) a chemical species comprising no free isocyanates groups and on average one or more hydrolysable silane group is possible, too. The term “chemical species” is used as defined above for chemical species Ba).

However, if present at all, the content of such species in component B is preferably less than 20 wt.-%, more preferred less than 15 wt.-% and even more preferred less than 10 wt.-% based on component B. Such compounds may be, e.g., by-products obtained in the manufacture of the Ba) chemical species, in case all isocyanate groups are consumed by the monosilane or bissilane brought into reaction with the starting diisocyanate or polyisocyanates.

Chemical Species Bd) Comprising on Average More than Zero, but Less than One Free Isocyanate Group and/or on Average More than Zero, but Less than One Hydrolysable Silane Group

Chemical species Bd) differ from chemical species Ba), Bb) and Bc) and might be by-products in the manufacture of chemical species Ba), Bb) and Bc).

### Component C

Optional component C of the two-pack coating composition of the present invention consists of Ca) one or more aprotic organic solvents. Thus, it is possible to form a storage stable pre-mix of the ingredients, i.e., solvents, of component C with either component A or component B or both and/or other components or ingredients as will be described below (such as for component D). Nevertheless, for calculations regarding to the amounts of ingredients and components, such solvents of component C are not regarded as part of component A or B or both or other components or ingredients. The aprotic organic solvents can be selected from aromatic or aliphatic hydrocarbons, such as e.g., Solvent Naphtha, or polar aprotic solvents such as ethers, esters and ketones.

Suitable esters are, e.g., methyl acetate, ethyl acetate, propyl acetate, butyl acetate, iso-butyl acetate, sec-butyl acetate and alkoxyalkyl acetates; suitable ketones are, e.g., acetone, methyl ethyl ketone and methyl isobutyl ketone; and suitable ethers are, e.g., 1-methoxy-2-propyl acetate, which also belongs to the esters.

### Component D

Optional component D of the two-pack coating composition comprises one or more ingredients selected from the group consisting of Da) one or more coatings additives, Db) one or more colorants, selected from dyes and pigments, Dc) resins which differ from any of the ingredients of afore-mentioned components A, B, C and Da; Dd) solvents other than the solvents of component C; and preferably De) one or more catalysts for crosslinking the crosslinkable ingredients of two-pack coating composition of the present invention.

### Da) Coatings Additives

Any typical coating additive used in topcoats, particularly in clear coats can be used in the coating compositions according to the present invention. Of course, if an additive interferes with the aim of the present invention, its amount should be reduced or it should be omitted from the coating composition at all. Preferred coatings additives which can be used in the coating compositions according to the present invention can be divided into two groups, namely i) additives affecting the properties of the coating compositions before cure, such as pigment wetting and dispersing additives; rheological additives, such as rheology enhancing additives, like silicas or other inorganic fillers; substrate wetting additives, such as surface tension modifiers; defoamers and deaerators; antioxidants; and formulation stabilizers; and ii) additives affecting the properties of the coating formed after cure, such as surface control additives, like flow and leveling agents; slip control additives like siloxane-based slip additives or waxes; and scratch resistance additives such as metal oxide nanoparticles or semi metal oxide nanoparticles, like silica nanoparticles; matting agents, such as waxes and synthetic silicas, like silica gels, precipitated silicas or fumed silicas; adhesion promoting additives; UV absorbers; and light stabilizers such as hindered amine light stabilizers.

Amongst the above additives, UV absorbers and light stabilizers; and metal oxide nanoparticles or semimetal oxide nanoparticles such as silica nanoparticles are most preferably used.

Amongst the UV absorbers, UV absorbers of the hydroxyphenylbenzotriazole class are preferred, particularly to prevent initial yellowing of the coating. Such UV absorbers are commercially available from BASF Corp. and Shanghai Tiansheng Chemical Co., Ltd.

Amongst the light stabilizers particularly preferred are liquid hindered amine light stabilizers, which are also available from BASF Corp.

Furthermore, it was found that metal oxide nanoparticles and semimetal oxide nanoparticles, which are typically used for the improvement of scratch resistance, such as silica nanoparticles may further improve the icephobicity of the coatings obtained from the coating compositions. Such nanoparticles may optionally be surface-treated, e.g., with organosilanes to, e.g., enhance hydrophobicity of the particles. Herein the volume-based median size of any type of metal oxide nanoparticles and semimetal oxide nanoparticles (D₅₀) is preferably in the range from 5 to 250 nm, more preferred in the range from 10 to 100, even more preferred in the range from 15 to 50 nm, such as 15 to 30 nm, as determined by dynamic light scattering using Malvern Zetasizer Nano series as DLS particle size analyzer, which is available from the company Malvern (e.g., model ZEN1690). Such silica nanoparticles are, e.g., available from Byk Chemie GmbH under the tradename Nanobyk-3652.

db) Colorants, Selected from Dyes and Pigments

The coating compositions according to the present invention may contain colorants. The colorants are typically selected from dyes (i.e., colorants which are soluble in the coating compositions) and pigments (i.e., colorants which are insoluble in the coating compositions). Since the coating compositions of the present invention are preferably clearcoat compositions, particularly pigments should either be used, if at all, in very low amounts (tinting amounts) or as transparent pigments, thus allowing visible light to transmit through the cured coating layer obtained from the coating compositions according to the present invention. Preferred amounts of colorants are in the range from 0 to 3 wt.-%, more preferred in the range from 0.1 to 1 wt.-% and most preferred in the range from 0.2 to 0.5 wt.-%, based on the total solids content of the coating composition.

Dc) Resins which Differ from the Other Ingredients

The coating compositions according to the present invention may contain Dc) further resins, which differ from all afore-mentioned resins. Particularly Si-free resins may be comprised in the coating compositions of the present invention. However, it was observed, that the presence of such further resins does typically not contribute to the icephobicity. To the contrary, larger amounts of such resins, e.g., 10 wt.-% based on the total weight of the coating composition might even be detrimental to the icephobicity behavior of the coatings formed from the coating compositions of the present invention. Consequently, it is preferred that the coating composition contains not more than 10 wt.-% of Dc) resins which differ from the other ingredients, such as 0 to 10 wt.-%, more preferred 0 to 8 wt.-% such as 1 to 5 wt.-%, based on the total weight of the coating composition.

Dd) Solvents Other than the Solvents of Component C

While it is not encouraged to use larger amounts of Dd) solvents, other than the solvents of component C in the coating compositions according to the present invention, such solvents, particularly protic solvent and/or water might be present to a low extend. Such solvents are typically not intentionally employed in the coating compositions, but introduced as solvents contained in the commercial products used e.g., as ingredients of the Da) additives, Db) colorants and/or Dc) resins of component D. If such solvents are present, their amount is preferably less than 10 wt.-%, more preferred less than 5 wt. % and even more preferred 0 to 3 wt.-% such as 0 to 1 or 2 wt.-% based on the total weight of the coating compositions according to the present invention.

### De) Catalysts for Crosslinking the Crosslinkable Ingredients of the Coating Composition of the Present Invention

The two-pack coating compositions of the present invention preferably comprise one or more catalysts for the crosslinking of hydrolysable silane groups with each other or with OH groups and one or more catalysts for the crosslinking of isocyanate groups with isocyanate reactive groups, like OH groups; or one or more catalysts catalyzing both afore-mentioned types of reactions.

### Catalysts for Crosslinking Hydrolysable Silane Groups

Suitable catalysts for the silane crosslinking reactions are phosphorous containing catalysts, as well as phosphorous and nitrogen containing catalysts, as e.g., amine neutralized phosphate catalysts such as Nacure 4167, zinc complex catalysts such as K-KAT 670, zinc-amine complex catalysts such as K-KAT XK-648, the latter one also being apt to catalyze the OH—NCO reaction; all aforementioned catalysts are obtainable from King Industries; or mono- or dialkylesters of phosphoric acid, such as 2-ethylhexyl acid phosphates like JP-508 from Ethox Chemicals LLC. Further catalysts of this kind are e.g., disclosed in WO 2016/202588 A1 as catalysts (D). Furthermore, e.g., tetra-n-butylammonium benzoate can be used as catalyst for the silane crosslinking reactions.

Catalysts for Crosslinking Isocyanate Reactive Groups with Isocyanate Groups

Suitable catalysts for the reaction of isocyanate reactive groups such as hydroxyl groups with isocyanate groups may be selected from the group of carboxylates of zinc and/or bismuth; chelates of aluminum, zirconium, titanium and/or boron; organotin compounds such as dibutyltin dilaurate (DBTL) and diocyltin dilaurate (DOTL); diazabicycloundecen (DBU), 1,5,7-triazabicyclo[4.4.0]dec-5-ene; and/or inorganic tin-containing catalysts, and mixtures thereof. Further catalysts for the reaction of isocyanate reactive groups such as hydroxyl groups with isocyanate groups are, e.g., disclosed in WO 2016/202588 A1 as catalysts (Z).

Preferably, the coating compositions of the present invention comprise one or more catalysts for silane crosslinking reactions and one or more catalysts for the reaction of isocyanate reactive groups such as hydroxyl groups with isocyanate groups; and/or one or more catalysts catalyzing both, silane crosslinking reactions and the reaction of isocyanate reactive groups such as hydroxyl groups with isocyanate groups.

The presence and amount as well as the specific type of catalyst is chosen in dependence of the presence or absence of organic species Ba) and/or Bb). If species Ba) are predominantly present in component B it is advisable to use more catalysts for silane crosslinking reactions than in case of using organic species Bb) as predominant species in component B, when it is advisable to use more of catalysts for the reaction of isocyanate reactive groups such as hydroxyl groups with isocyanate groups. A good compromise is to use a catalyst which catalyzes both types of reactions, such as K-KAT XK-648, along with either a catalyst for silane crosslinking reactions, such as an amine neutralized phosphate catalyst or phosphate ester catalyst, if organic species Ba) are only or predominantly used or with a catalyst for the reaction of isocyanate reactive groups such as hydroxyl groups with isocyanate groups, such as an organotin catalyst, if organic species Bb) are only or predominantly used.

However, any mixture of catalysts can be used in dependence of the type and amount of organic species Ba) and/or Bb).

### Amounts and Ratios of Components and Ingredients of the Coating Composition

As is common in chemistry, whenever a component or ingredient is herein referred to with respect to amounts and ratios, the substance is meant as such and not any dispersion or solution thereof in a solvent. This is particularly the case, if amounts by weight, weight percentages, weight ratios and molar ratios are provided herein. As an example, if 100 parts by weight of an 80 wt.-%-solution of a chemical species Ba) dissolved in butyl acetate are employed in the coating composition, it is construed that only 80 parts by weight belong to the chemical species Ba) and 20 parts by weight belong to component C, which comprises Ca) one or more aprotic organic solvents.

The solids content of the 2-pack coating compositions of the present invention can vary in a wide range and is determined by weighing a sample of approx. 1 g of the composition and drying the composition at a temperature of 110° C. for 60 min. The residual solid part in relation to the weighed-in portion multiplied with 100 is the solids content of the coating composition in wt.-%. The difference to 100 wt.-% is the volatile content of the coating compositions, which mainly consists of the volatile solvents employed in the coating compositions.

Particularly depending on the application method, such as spray or dip application different solvent contents and thus, different solids contents may be used.

Particularly preferred, the solids content of the coating compositions of the present invention is rather high to avoid environmental problems which might be associated with high solvent contents. Preferably the solids content is at least 30 wt.-%, more preferred at least 40 wt.-%, even more preferred at least 50 wt.-% and most preferred at least 55 wt.-%, based on the total weight of the coating composition. While solids contents of 100 wt.-% are not excluded, it is, for application reasons preferred that the upper limit of the solids content is up to 95 wt.-%, more preferred up to 90 wt.-% and even more preferred up to 85 wt.-%, such as preferably from 30 to 95 wt.-%, more preferred 40 to 90 wt.-%, and even more preferred 50 or 55 to 85 wt.-%, based on the total weight of the coating composition.

The combined solids content of components A and B, based on the total solids content of the coating compositions of the present invention is preferably in the range from 75 wt.-% to 100 wt.-%, more preferred 80 to 99 wt.-%, even more preferred 85 to 98 wt.-% and most preferred 87 to 97 wt.-%, such as 88 to 96 wt.-%.

The weight ratio of the solids of component A to the solids of component B is preferably from 20:80 to 80:20, more preferred from 25:75 to 75:25 and even more preferred from 30:70 to 70:30. In case component B comprises 70 to 100 wt.-%, more preferred 80 tp 100 wt.-% of organic species Ba), based on the total weight of component B, the weight ratio of the solids of component A to the solids of component B is even more preferred from 35:65 to 65:35 and most preferred 40:60 to 60:40. Each of these ratios applies to any solids content range presented in the previous paragraph.

As shown in the experimental section of the present invention, the weight ratio of the total amount of the Aa) one or more polysiloxanes with 4 or more isocyanate reactive groups and the total amount of the Ab) one or more organic polymer comprising a plurality of polysiloxane chains and isocyanate reactive functional groups, which differs from Aa) can vary in a wide range. Preferably, total amount of the Aa) one or more polysiloxanes with 4 or more isocyanate reactive groups based on the combined total amount of the Aa) one or more polysiloxanes with 4 or more isocyanate reactive groups and the Ab) one or more organic polymer comprising a plurality of polysiloxane chains and isocyanate reactive functional groups, is at least 40 wt.-%, more preferred at least 55 wt.-% and most preferred at least 60 wt.-%, however it can also be more than 90 wt.-%.

Furthermore, the molar ratio of isocyanate reactive groups in component A to free isocyanate groups in component B is from 0.5 to 1.5, more preferred from 0.7 to 1.2, and even more preferred from 0.9 to 1.1. The aforementioned molar ratio ranges are independent of the kind of isocyanate reactive groups in component A. The isocyanate reactive groups are preferably OH groups, SH groups, primary and secondary amino groups or any combination thereof. Most preferred the isocyanate reactive groups are OH groups, even more preferred primary OH groups, thus, the afore-mentioned ratios do also apply to the molar ratio of OH groups to free isocyanate groups.

Preferably, the combined solids content of the Da) one or more coatings additives ranges from 2 to 15 wt.-%, more preferred 3 to 13 wt.-%, even more preferred 5 to 11 wt.-%, based on the total solids content of the coating composition.

The UV absorbers, which are part of the Da) one or more coatings additives are preferably present in a solids content of 1 to 7 wt.-%, more preferred in an amount of 2 to 6 wt.-% and most preferred in an amount of 3 to 5 wt.-%, based on the total solids content of the coating compositions of the present invention.

The light stabilizers, which are also part of the Da) one or more coatings additives are preferably present in a solids content of 0.1 to 4 wt.-%, more preferred in an amount of 0.3 to 4 wt.-% and most preferred in an amount of 0.5 to 3 wt.-%, such as 0.7 to 2 wt.-% or 0.9 to 1.5 wt.-%, based on the total solids content of the coating compositions of the present invention.

If metal oxide nanoparticles or semi metal oxide nanoparticles, like silica nanoparticles, are present in the coating compositions according to the present invention, their amount preferably ranges from 0.5 to 5 wt.-%, more preferred 1.0 to 4 wt.-%, even more preferred from 1.5 to 3.5 wt.-%, based on the total solids content of the coating compositions.

Particularly preferred, the combined solids content of De) all catalysts serving to catalyze the silane crosslinking reactions and all catalysts serving the crosslinking between isocyanate reactive groups and isocyanate groups, based on the total solids content of the coating composition, is in the range from 0.5 to 8 wt.-%, more preferred 1 to 7 wt.-%, even more preferred 2 to 6 wt.-% and most preferred 3 to 6 wt.-%.

### Method of Forming a Cured Coating Layer on a Surface of a Substrate

A further subject-matter of the present invention is a method of forming a cured coating layer at least partially on at least one surface of a substrate, wherein said method comprises the following steps:
(a) applying the coating composition according to the present invention at least partially onto at least one surface of an optionally pre-coated substrate to form a coating layer on the surface of the substrate; and subsequently
(b) curing the coating layer obtained in step (a) to form a cured coating layer on the surface of the substrate.

Curing of the coating layer obtained in step (b) can be accomplished at a temperature of 20° C., but also at an elevated temperature, depending on the types and amounts of crosslinking catalysts and the type of the substrate to be coated. Preferred curing temperatures range from 20 to 120° C., more preferred 30 to 100° C., and most preferred at a temperature in the range of 40 to 90° C. Preferred dry layer thicknesses are in the range from 10 to 100 μm, more preferred 20 to 80 μm, even more preferred, 30 to 70 μm, such as 40 to 60 μm.

All preferred embodiments described herein above in connection with the coating composition according to the invention, are also preferred embodiments of the method according to the invention.

The coating composition is preferably the uttermost coating layer applied to the substrate.

The pre-coated or not precoated substrate can be a metallic substrate or a plastic substrate, i.e., a polymeric substrate; or glass.

The term “metallic substrate” encompasses any type of solid metal and alloys thereof. Particularly preferred metallic substrates are bare steel, galvanized steel, zinc, aluminum, magnesium, copper and alloys of the aforementioned metals. Most preferred substrates are steel, like cold rolled steel; galvanized steel, such as hot dip galvanized steel and electrogalvanized steel; and aluminum and its alloys.

If the substrate is a metallic substrate, such as an automotive body, it is preferred that the substrate is pre-coated, preferably with a conversion coating layer as a pre-treatment, followed by an electrodeposition coating layer, and one or more primer layers and/or one or more basecoat layers and even, in some cases a clear coat.

Preferably, if the metallic substrate is coated with a conversion coating layer and an electrodeposition coating layer, a thus coated substrate is also pre-cured. Any following layers, such as one or more primer layers and one or more basecoat layers can be cured separately; or, if they are applied wet-on-wet, they can be cured in one step together with the coating layer which is applied according to the method according to the present invention.

The substrate used can also be a plastic substrate, i.e., a polymeric substrate. Suitable polymers are poly(meth)acrylates including polymethyl(meth)acrylates, polybutyl (meth)acrylates, polyethylene terephthalates, polybutylene terephthalates, polyvinylidene fluorides, polyvinyl chlorides, polyesters, including polycarbonates and polyvinyl acetate, polyamides, polyolefins such as polyethylene, polypropylene, polystyrene, and also polybutadiene, polyacrylonitrile, polyacetal, polyacrylonitrile-ethylene-propylene-diene-styrene copolymers (A-EPDM), ASA (acrylonitrile-styrene-acrylic ester copolymers) and ABS (acrylonitrile-butadiene-styrene copolymers), polyetherimides, phenolic resins, urea resins, melamine resins, alkyd resins, epoxy resins, polyurethanes, including TPU, polyetherketones, polyphenylene sulfides, polyethers, polyvinyl alcohols, and mixtures thereof. Polycarbonates and poly(meth)acrylates are especially preferred. The plastic substrate can also be a composite substrate such as a fiber reinforced substrate containing e.g., glass fibers, carbon fibers or polymeric fibers such as polyamide fibers. The plastic substrate can also consist of multiple polymeric layers.

If the substrate is a plastic substrate, it may also be a pre-coated substrate, which, e.g., bears a primer coating layer or adhesion promoting layer, but does not have to.

The coating composition according to the invention can be coated on an object by numerous techniques well-known in the art, including spray coating, drop coating, dip coating, roll coating, curtain coating, and other techniques. Preferably, the inventive coating compositions are applied by spray coating, more preferred by pneumatic or electrostatic spray coating. It can be applied wet-on-wet on subjacent coating layers, but does not have to.

### Use of the Coating Compositions

The coating compositions according to the present invention can be used for providing an icephobic coating to various substrates.

Particularly preferred are substrates, such as aircrafts and parts thereof like an airframe, fuselage and wings; vehicles bodies, such as automotive bodies and parts thereof; and wind turbines and parts thereof, such as rotor blades.

### EXAMPLES

In the following, if not stated otherwise, parts are parts by weight (pbw) and percentages are percentages by weight (wt.-%).

### Analytical Methods

### Determination of the Number-Average Molecular Weight Mn and Weight-Average Molecular Weight M_{w}

The number-average and weight-average molecular weights of the resins, oligomers and polymers as used in the present invention are determined by gel permeation chromatography using a polystyrene standard and tetrahydrofuran as diluent.

### Determination of the Hydroxyl Number

The hydroxyl number of the resins, oligomers and polymers as used in the present invention was determined in accordance with DIN EN ISO 4629-2 (December 2016).

### Determination of the Solids Content

The solids content (in weight-%) of each component, ingredient of a component or the coating composition itself was determined by weighing a sample of approx. 1 g, subsequently drying the sample at 110° C. for 60 min and determining the weight of the residue left. The ratio of the residue left after drying and the weight of the original sample is multiplied by 100 to get the solids content in percent by weight.

### INVENTIVE AND COMPARATIVE EXAMPLES

In the following it is explained how the inventive Examples 1 to 9 and the Comparative Examples 1 to 4 including the therewith coated steel panels were obtained.

### Examples 1 to 4

The ingredients, summarized under positions 1 and 2 (Table 1) were mixed under low shear mixing. Thereto, the ingredient under position 5 (Table 1) was added slowly under mixing. To this mixture the ingredients under positions 6 to 9 (Table 1) were added and mixed. This mixture is called component A. Subsequently, component A is mixed with the ingredient of position 10 (component Ba) of Table 1 to obtain the icephobic coating composition.

The icephobic coating compositions were applied to an E-coated (CG-500 from BASF) steel panel with a drawdown applicator. The panels were allowed to flash-off for 10 min at room temperature and were baked at approx. 88° C. (approx. 190° F.) for 30 min. The dry layer thicknesses of the thus obtained icephobic coating layers were about 40 to 50 μm (approx. 1.8 mil).

### Example 5

As described for Examples 1 to 4 above, the icephobic coating composition as used in Example 5 was prepared (for the ingredients see Table 1), with the modification, that the ingredients of positions 3 and 4 (Table 1) were added and mixed to the mixture obtained by mixing positions 1 and 2 and before adding the ingredient of position 5.

Onto a steel panel coated with a cured conventional primer (commercially available from BASF), a commercially available, water-borne black basecoat (Shadow Black from BASF) was applied by spray application. The obtained basecoat layer dry layer thickness of approx. 11.5±1.5 μm) was subjected to a 10 min flash-off at room temperature followed by a 7 min flash-off at approx. 66° C. (approx. 150° F.). The iceophobic coating composition was applied to the basecoat layer by spray coating. The panel was allowed to flash-off for 10 min at room temperature and was cured at approx. 88° C. (approx. 190° F.) for 30 min. The dry layer thickness of the thus obtained icephobic coating layer was about 40 to 50 μm (approx. 1.8 mil).

### Example 6

The icephobic coating composition as used in Example 6 was prepared in the same manner as the icephobic coating composition described in Example 5. The respective amounts of ingredients are found in Table 1.

A steel panel was coated with an EverGloss OEM coating system (baked primer, Shadow Black basecoat and EverGloss 905 clearcoat) from BASF Coating GmbH by spray application. The coating system was baked at approx. 88° C. (approx. 190° F.) for 30 min. The icephobic coating composition was applied to the baked EverGloss OEM coating system by spray coating. The panel was allowed to flash-off for 10 min at room temperature and was cured at approx. 88° C. (approx. 190° F.) for 30 min. The dry layer thickness of the thus obtained icephobic coating layer was about 40 to 50 μm (approx. 1.8 mil).

### Examples 7 and 8

The ingredients, summarized under positions 1 and 2 (Table 1) were mixed under low shear mixing. Thereto, the ingredients under positions 3 to 7 (Table 1) were added slowly under mixing. To this mixture the ingredients under positions 8 to 9 (Example 7) or under position 9 (Example 8) were added and mixed. These mixtures are called component A. Subsequently, component A is mixed with component B, i.e., the ingredient of position 11 (Example 7) or the ingredients of positions 10 and 11 (Example 8) of Table 1 to obtain the icephobic coating compositions.

The icephobic coating compositions were applied to an E-coated (CG-500 from BASF) steel panel with a drawdown applicator. The panels were allowed to flash-off for 10 min at room temperature and were baked at approx. 88° C. (approx. 190° F.) for 30 min. The dry layer thicknesses of the thus obtained icephobic coating layers were about 40 to 50 μm (approx. 1.8 mil).

### Example 9

The ingredients, summarized under positions 1 and 2 (Table 1) were mixed under low shear mixing. Thereto, the ingredients under positions 5 to 7 (Table 1) were added slowly under mixing. To this mixture the ingredients under position 9 was added and mixed. These mixtures are called component A. Subsequently, component A is mixed with component B, i.e., the ingredient of position 12 of Table 1 to obtain the icephobic coating compositions.

The icephobic coating compositions were applied to an E-coated (CG-500 from BASF) steel panel with a drawdown applicator. The panels were allowed to flash-off for 10 min at room temperature and were baked at approx. 88° C. (approx. 190° F.) for 30 min. The dry layer thicknesses of the thus obtained icephobic coating layers were about 40 to 50 μm (approx. 1.8 mil).

### Comparative Examples 1 to 4

The icephobic coating compositions as used in Comparative Example 1 to 4 were prepared in analogy to the icephobic coating composition described in Examples 1 to 4. The respective amounts of ingredients are found in Table 1. The testing panels were also prepared in accordance with Examples 1 to 4. The dry layer thicknesses of the thus obtained coating layers were about 40 to 50 μm (approx. 1.8 mil).

### Test and Results

### Ice Block Fall Test Under Gravitational Force

In this test method, cylindrical polyvinylchloride (PVC) molds (22 mm inner diameter and 30 mm height) were used to create ice blocks on coated panels as follows. The coated panels were placed inside a freezer maintaining a temperature of −20° C. Subsequently, three PVC molds were placed vertically on the coated panels. The PVC molds were filled with deionized water. Then the panels were kept inside the freezer for about 1 to 1.5 hours to allow the deionized water to completely freeze. The panels were then taken out of the freezer, connected to a thermocouple (for recording temperature) and held outside the freezer in vertical position. The temperature at which ice blocks dropped under gravitational force was recorded and is denoted as ice block falling temperature (IBF temperature).

If a coating is not icephobic at all, the ice blocks will not drop until the melting temperature is reached. The coatings are more icephobic when the IBF temperature is lower.

Examples 1 and 2 differ in the amount of the inventive crosslinker 1 (2.15 and 2.0 pbw, respectively), resulting in different molar ratios of OH:NCO groups being 1:1.04 (Example 1) and 1:0.96 (Example 2). However, in both cases the IBF temperature is about −20° C. and thus excellent. Even after three or five months outdoor exposure, the IBF temperature is almost the same.

Example 3 makes use of the same molar amounts of OH groups as in Examples 1 and 2, but with varying amounts of compounds in positions 1 and 2. Again even less crosslinker 1 is used (1.85 pbw) compared to Examples 1 and 2, resulting in a molar ratio of OH:NCO groups being 1:0.89. Thus, Examples 3 shows that the amounts of positions 1 and 2 might be varied and that an even lower amount of crosslinker 1 still gives the same excellent OBF temperatures, even after 3 months of outdoor exposure.

Example 4 differs from Example 1 only in that surface-treated silica nanoparticles (Nanobyk 3652) were omitted in Example 4. Such and other silica nanoparticles are often used in top coats, particularly clearcoats to improve scratch resistance and sag resistance as well as hardness and the like. The lack of the nanoparticles results in a still acceptable IBF temperature of −10±2° C., which again is still a big improvement compared to the non-inventive Comparative Examples 1 to 3.

The coating compositions used in Examples 1 and 5 are the same. However, the compositions were applied onto differently pre-coated substrates. Nevertheless, the IBF temperatures are the same, i.e., −20±2° C. This shows that the performance of the icephobic coatings, i.e., the IBF temperature is still excellent.

Examples 5 and 6 again differ in the pre-coating of the substrate. Example 6 makes use of a substrate precoated with the complete EverGloss OEM system as available from BASF Coating GmbH. The IBF temperature of −10±2° C., is still a big improvement compared to the non-inventive Comparative Examples 1 to 3.

Example 7 differs from Examples 1 to 6 in that instead of the Ba) chemical species, which comprises on average one or more free isocyanates groups and on average one or more hydrolysable silane groups, a Bb) chemical species is employed, comprising on average two or more free isocyanates groups and no hydrolysable silane groups. Thus, in Example 7—compared to the other examples—more isocyanate groups are involved in the crosslinking reactions, thus a typical tin catalyst was added, namely dibutyl tin dilaurate, which is known as a catalyst for the isocyanate-hydroxyl reaction, while most of the silane crosslinking catalysts were omitted except for K-KAT XK-651, which however catalyzes both the silane crosslinking and the OH/NCO crosslinking likewise. As shown in Table 1, an excellent IBF temperature was reached, even without a chemical species of type Ba).

Example 8 is, with respect to components A and B, similar to Example 6, except for substituting some of the crosslinker 1 (Ba) by crosslinker 2 (Bb), and minor differences regarding the content of the UV absorber and light stabilizer. Thus, this example makes use of both, a crosslinker 1 (Ba) type) and a crosslinker 2 (Bb) type). This example shows that even using a crosslinker of the Bb) type, it is not required to use the tin catalyst of Example 7 to still get an excellent IBF temperature.

Example 9, contrary to the other examples, makes use of a biuret structure containing crosslinker of the Bb) type. Further, it is not required to use the tin catalyst of Example 7 to still get an excellent IBF temperature.

Comparative Examples 1 and 2 only differ from Example 1 in that position 1 (Comparative Example 1) or position 2 (Comparative Example 2) were omitted in the formulations. In both cases the IBF temperatures are above 0° C. and thus fail the requirements as set by the present invention.

Comparative Examples 3 and 4 are comparable with Comparative Examples 1 and 2 except for using an amount of crosslinker 1 (Ba) which guarantees that the molar ratio of OH to NCO groups is 1:1.04 in both examples. Although the OH-to-NCO molar ratio is in the preferred range, it is not possible to get satisfactory IBF temperatures since in both cases one of both components Aa) or Ab) is missing.

TABLE 1

| | | Examples | | | | | | | | | Comparative Examples | | | |
|---|---|---|---|---|---|---|---|---|---|---|---|---|---|---|
| Components | | 1 | 2 | 3 | 4 | 5 | 6 | 7 | 8 | 9 | 1 | 2 | 3 | 4 |
| 1 | Silmer OHT Di-10 (Aa) | 1.25 | 1.25 | 1.35 | 1.25 | 1.25 | 1.25 | 1.25 | 1.25 | 1.25 | 0.00 | 1.25 | 0.00 | 1.25 |
| 2 | Silclean 3700 (Ab) | 2.50 | 2.50 | 0.37 | 2.50 | 2.50 | 2.50 | 2.50 | 2.50 | 2.50 | 2.50 | 0.00 | 2.50 | 0.00 |
| 3 | Tinuvin 384-2 | 0.00 | 0.00 | 0.00 | 0.00 | 0.12 | 0.12 | 0.00 | 0.20 | 0.00 | 0.00 | 0.00 | 0.00 | 0.00 |
| 4 | Tinuvin 292 | 0.00 | 0.00 | 0.00 | 0.00 | 0.04 | 0.04 | 0.00 | 0.07 | 0.00 | 0.00 | 0.00 | 0.00 | 0.00 |
| 5 | JP-508 | 0.05 | 0.05 | 0.05 | 0.05 | 0.05 | 0.05 | 0.00 | 0.05 | 0.05 | 0.05 | 0.05 | 0.05 | 0.05 |
| 6 | Nacure 4167 | 0.11 | 0.11 | 0.11 | 0.11 | 0.11 | 0.11 | 0.00 | 0.11 | 0.11 | 0.11 | 0.11 | 0.11 | 0.11 |
| 7 | K KAT XK-651 | 0.01 | 0.01 | 0.01 | 0.01 | 0.01 | 0.01 | 0.01 | 0.01 | 0.01 | 0.01 | 0.01 | 0.01 | 0.01 |
| 8 | Dibutyl tin dilaurate | 0.00 | 0.00 | 0.00 | 0.00 | 0.00 | 0.00 | 0.02 | 0.00 | 0.00 | 0.00 | 0.00 | 0.00 | 0.00 |
| 9 | Nanobyk 3652 | 0.30 | 0.30 | 0.30 | 0.00 | 0.30 | 0.30 | 0.30 | 0.30 | 0.30 | 0.30 | 0.30 | 0.30 | 0.30 |
| 10 | Crosslinker 1 (Ba) | 2.15 | 2.0 | 1.85 | 2.15 | 2.15 | 1.85 | 0.00 | 1.48 | 0.00 | 2.15 | 2.15 | 1.97 | 0.19 |
| 11 | Crosslinker 2 (Bb) | 0.00 | 0.00 | 0.00 | 0.00 | 0.00 | 0.00 | 1.10 | 0.20 | 0.00 | 0.00 | 0.00 | 0.00 | 0.00 |
| 12 | Crosslinker 3 (Bb) | 0.00 | 0.00 | 0.00 | 0.00 | 0.00 | 0.00 | 0.00 | 0.00 | 3.04 | 0.00 | 0.00 | 0.00 | 0.00 |

| Substrate | 1 | | | | 2 | 3 | 1 | | | 1 | | | |
|---|---|---|---|---|---|---|---|---|---|---|---|---|---|
| IBF temperature (° C.) | −20 ± 2 | −20 ± 2 | −20 ± 2 | −10 ± 2 | −20 ± 2 | −10 ± 2 | −20 ± 2 | −20 ± 2 | −20 ± 2 | 3 ± 2 | 1 ± 2 | 3 ± 2 | 4 ± 2 |
| IBF temperature (° C.) | −18 ± 2 | −18 ± 2 | −18 ± 2 | n.d. | n.d. | n.d. | n.d. | n.d. | n.d. | n.d. | n.d. | n.d. | n.d. |
| after outdoor exposure | (5) | (3) | (3) | | | | | | | | | | |
| (time in months) | | | | | | | | | | | | | |

n.d. = not determined
Substrate 1: e-coat (CG500) on steel panel;
Substrate 2: Steel panel coated with cured conventional primer and black water-borne basecoat (Shadow Black basecoat);
Substrate 3: Steel panel coated with EverGloss OEM Coating system (baked primer, Shadow Black basecoat and EverGloss 905 clearcoat)
Silmer OHT Di-10: Hydroxyalkyl modified silicone (100 wt.-% solvent-free, 4 primary terminal OH groups, equivalent weight 350 g/mol) from Siltech
Silclean 3700: Solution of a silicone-modified polyacrylate (25 wt.-% in methoxypropylacetate; OH number: 30 mg KOH/g) from BYK Chemie GmbH
Tinuvin 384-2: (95 wt.-% solids in methoxypropylacetate; UV absorber benzotriazole type) from BASF
Tinuvin 292: Hindered amine light stabilizer (100 wt.-%) from BASF
JP-508: 2-Ethylhexyl acid phosphate ((C₈H₁₇O)ₙ—(P═O)—(OH)₃₋ₙ, n = 1 and 2) from Ethox Chemicals LLC
Nacure 4167: Amine neutralized phosphate catalyst from King Industries
K KAT XK-651: Bismuth carboxylate catalyst from King Industries
Nanobyk 3652: Surface-treated silica nanoparticles from BYK (31 wt.-% total solids; 25 wt.-% nanoparticles; in methoxypropyl acetate/methoxypropanol)
Crosslinker 1: 51.58 pbw HDI isocyanurate modified with 1.5 pbw N-(n-butyl)-3-aminopropyl trimethoxysilane, 26.9 pbw bis(trimethoxysilylpropyl)amine and 20 pbw butyl acetate (NCO content 8.3 ± 0.4 wt.-%)
Crosslinker 2: 68.3 pbw HDI isocyanurate, 15.85 pbw Solvesso 100 and 15.85 pbw butyl acetate (NCO content 14.8 ± 0.3 wt.-%)
Crosslinker 3: 75.0 pbw HDI biuret, 25 pbw 1-methoxypropylacetate-2/xylene (1:1) (NCO content 16.5 ± 0.3 wt.-%)

1. A two-pack coating composition comprising
A) a component A comprising
Aa) one or more polysiloxanes with 4 or more isocyanate reactive groups; and
Ab) one or more organic polymers, which differ from Aa) and which comprise a plurality of polysiloxane chains and isocyanate reactive functional groups; and
B) a component B comprising
Ba) a chemical species, which comprises on average one or more free isocyanates groups and on average one or more hydrolysable silane groups; and/or
Bb) a chemical species comprising on average two or more free isocyanates groups and no hydrolysable silane groups.

2. The two-pack coating composition according to claim 1, wherein the Aa) one or more polysiloxanes with 4 or more isocyanate reactive groups, have the following formula (I): 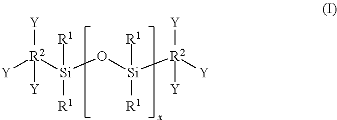
wherein the
R¹ groups are independently selected from the group consisting of alkyl groups having 1 to 4 carbon atoms and phenyl groups; the
R² groups are independently selected from the group consisting of branched or linear aliphatic hydrocarbon groups, which may be interrupted by one or more ether oxygen atoms; the
Y groups are independently H or isocyanate reactive groups, with the proviso that at least 4 Y groups are isocyanate reactive groups; and
x is a number in the range from 4 to 40.

3. The two-pack coating composition according to claim 2, wherein Y stands for OH groups.

4. The two-pack coating composition according to claim 1, wherein the Aa) one or more polysiloxanes with four or more isocyanate reactive groups have an OH value in the range from 100 to 400 mg KOH/g.

5. The two-pack coating composition according to claim 1, wherein the Ab) one or more organic polymers have an organic polymeric backbone selected from the group consisting of polyesters, polyurethanes and poly(meth)acrylates, and a plurality of terminal and/or pendant polysiloxane chains.

6. The two-pack coating composition according to claim 1, wherein the Ab) one or more organic polymers have hydroxyl groups as isocyanate reactive groups.

7. The two-pack coating composition according to claim 1, wherein the Ab) one or more organic polymers have a poly(meth)acrylate backbone and the plurality of polysiloxane chains are pendant from the backbone.

8. The two-pack coating composition according to claim 1, wherein the Ab) one or more organic polymers have an OH value in the range from 5 to 100 mg KOH/g.

9. The two-pack coating composition according to claim 1, wherein the Ba) a chemical species, which comprises on average one or more free isocyanates groups and on average one or more hydrolysable silane groups are reaction products of a diisocyanate or polyisocyanate with compounds of the following formula (II)
H—Z—X—Si(Rⁱ)_{y}(ORⁱⁱ)_{3-y} (II)
wherein
Z=NH, NRⁱⁱⁱ or O;
y=0, 1 or 2;
Rⁱ=are independently of each other alkyl groups having 1 to 4 carbon atoms;
Rⁱⁱ=are independently of each other H or alkyl groups having 1 to 4 carbon atoms;
Rⁱⁱⁱ=a hydrocarbon group having 1 to 10 carbon atoms, or a hydrocarbon group being interrupted by one or more of the following groups —O—, —S— or NR^{iv}, wherein R^{iv} being an alkyl group with 1 to 6 carbon atoms, a cycloalkyl group with 3 to 10 carbon atoms, an aryl group with 6 to 10 carbon atoms or aralkyl group with 7 to 10 carbon atoms; or Rⁱⁱⁱ being a group X—Si(Rⁱ)_{z}(ORⁱⁱ)_{3-z}, wherein z=0, 1 or 2; and
X=a linear or branched alkylene group having 1 to 20 carbon atoms or a cycloalkylene group having 3 to 14 atoms.

10. The two-pack coating composition according to claim 1,
wherein the
Ba) a chemical species, which comprises on average one or more free isocyanates groups and on average one or more hydrolysable silane groups has the formula (III) 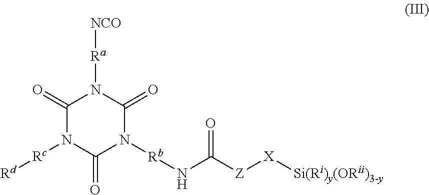
wherein
Z=NH, NRⁱⁱⁱ or O;
y=0, 1 or 2;
Rⁱ=are independently of each other alkyl groups having 1 to 4 carbon atoms;
Rⁱⁱ=are independently of each other H or alkyl groups having 1 to 4 carbon atoms;
X=a linear or branched alkylene group having 1 to 20 carbon atoms or a cycloalkylene group having 3 to 14 atoms;
R^{a}, R^{b} and R^{c} are independently of each other aliphatic or aromatic hydrocarbon groups; and
R^{d} being an isocyanate group or an NH—(C=O)—Z—X—Si(Rⁱ)_{y}(ORⁱⁱ)_{3-y} group;
and/or in that the
Bb) a chemical species, which comprises on average two or more free isocyanates groups and no hydrolysable silane groups has the formula (IV): 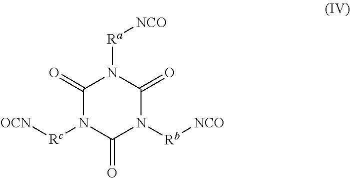
wherein
R^{a}, R^{b} and R^{c} are independently of each defined as for formula (III).

11. The two-pack coating composition according to claim 1, further
comprising
component C, consisting of Ca) one or more aprotic organic solvents; and/or
ingredients, selected from the group consisting of Da) one or more coatings additives, Db) one or more colorants, selected from the group consisting of dyes and pigments, Dc) resins which differ from any of the ingredients of afore-mentioned components A, B, C and Da;
Dd) solvents other than the solvents of component C; and De) one or more catalysts which catalyze the crosslinking reactions of the crosslinkable ingredients of the coating composition.

12. The two-pack coating composition according to claim 1, wherein it further contains Da) one or more nanoparticles, selected from the group consisting of metal oxide nanoparticles and semimetal oxide nanoparticles.

13. The two-pack coating composition according to claim 1, wherein it contains, De) one or more catalysts selected from the group consisting of
i. crosslinking catalysts, catalyzing the crosslinking reaction of hydrolysable silane groups;
ii. crosslinking catalysts for the reaction of isocyanate reactive groups with isocyanate groups; and
iii. crosslinking catalysts, catalyzing the crosslinking reaction of hydrolysable silane groups and catalyzing the reaction of isocyanate reactive with isocyanate groups.

14. A method of forming a cured coating layer at least partially on at least one surface of a substrate, wherein said method comprises the following steps:
(a) applying the two-pack coating composition of claim 1 at least partially onto at least one surface of an optionally pre-coated substrate to form a coating layer on the surface of the substrate; and subsequently
(b) curing the coating layer obtained in step (a) to form a cured coating layer on the surface of the substrate.

15. A method of using the two-pack coating composition of claim 1, the method comprising using the two-pack coating composition to provide an icephobic coating to substrates.
